(19) United States
(12) Patent Application Publication
(10) Pub. No.: US 2002/0048535 A1
(43) Pub. Date: Apr. 25, 2002

(54) Rotation device for sequential microfluidic reaction

(76) Inventors: Bernhard H. Weigl, Seattle, WA (US); Ronald L. Bardell, Redmond, WA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/956,485

(22) Filed: Sep. 18, 2001

Related U.S. Application Data
(60) Provisional application No. 60/233,396, filed on Sep. 18, 2000.

(51) Int. Cl. B01L 3/00

(52) U.S. Cl. 422/100; 422/102; 436/180

(57) ABSTRACT

A method and apparatus for performing a microfluidic process. An apparatus includes an arrangement comprising a first tank and a second tank having an inlet connected to an outlet of the first tank. The arrangement also includes a third tank adjacent to the first tank and a fourth tank, adjacent to the second tank, and having an inlet connected to an outlet of the third tank. The arrangement further includes a microfluidic channel having a first inlet connected to an outlet of the second tank, a second inlet connected to an outlet of the fourth tank, and a first outlet connected to an inlet of the first tank. In operation, the first and third tank are filled with fluids in a first, initial position. The arrangement is rotated to transfer the fluids to respective second and fourth tanks in a second position, and then rotated back to the first position where the fluids enter the microfluidic channel. The steps can be repeated until the desired process is accomplished.

### RELATED APPLICATION

This application claims priority from U.S. Provisional Patent Application No. 60/233,396, filed Sep. 18, 2000, entitled “Microfluidic Systems and Methods”.

### BACKGROUND OF THE INVENTION

This invention relates to microfluidic structures. In particular, this invention provides microfluidic structures, devices and methods in which a microfluidic flow process can be conducted within a minimal space and without external drivers.

Microfluidics has become increasingly popular in recent years for testing, analysis and for performing a wide range of biological, chemical and/or physical processes. Using fabrication techniques and tools developed by the semiconductor industry, many applications are being developed that rely on microfluidics, such as intricate “lab on a chip” platforms.

Some microfluidic processes require time-consuming interaction between two or more fluids. Presently, microfluidic platforms that can accommodate such lengthy processes employ long fluid channels and intricate fluid movement systems. Such platforms also need complex power sources for powering those fluid movement systems. The intricacy and complexity of most microfluidic platforms are costly, and do not usually allow for multiple iterations of a process to accomplish the desired interaction.

### BRIEF DESCRIPTION OF THE DRAWING

FIG. 1 shows a cartridge including a manual extraction device.

FIGS. 2a-h illustrate a sequence of rotations to perform the manual extraction with the device shown in FIG. 1.

FIG. 3 shows an alternative embodiment of a cartridge including a manual diluation device.

FIGS. 4a-h illustrate a sequence of rotations to perform the manual diluation with the device shown in FIG. 3.

### DETAILED DESCRIPTION OF THE PREFERRED EMBODIMENTS

This invention relates to microfluidics. As used herein, the term “microfluidic” generally refers to fluid-containing structures having at least one internal cross-sectional dimension between 0.1 and 500 micrometers, and/or conforming to the following formula:

0.1<(Smallest Cross-sectional dimension (in micrometers))×(viscosity of fluid)/(aqueous viscosity)<500.

Microfluidic also refers to the uses and advantages of fluidic properties at such micro-scale.

This invention, embodied as an apparatus, includes a first tank, and a second tank having an inlet connected to an outlet of the first tank. The apparatus includes a third tank adjacent to the first tank, and a fourth tank, adjacent to the second tank, which has an inlet connected to an outlet of the third tank. The apparatus further includes a microfluidic channel, having a first inlet connected to an outlet of the second tank, a second inlet connected to an outlet of the fourth tank, and a first outlet connected to an inlet of the first tank.

In one embodiment, the first, second, third and fourth tanks are disposed within a common plane, and formed into a cartridge-like structure. The cartridge, or apparatus, can be partially filled with at least two different fluids, and then rotated to several positions so that the different fluids flow from one tank to another. The tanks are formed and arranged so as to produce a fluid flow in at least one, and in most cases only one, desired direction, depending on the orientation or position of the cartridge or apparatus.

In a method according to an embodiment of the invention, a microfluidic process is performed by providing a first fluid to a first tank of the device, and transferring at least a portion of the first fluid to a second tank of the device via an inlet connected to an outlet of the first tank. The method further includes providing a second fluid to a third tank of the device, the third tank preferably adjacent to the first tank, and transferring at least a portion of the second fluid to a fourth tank of the device via an inlet connected to an outlet of the third tank. The fourth tank is preferably adjacent to the second tank. The method further includes combining the first fluid from the second tank with the second fluid from the fourth tank in a microfluidic channel of the device, via a first inlet connected to an outlet of the second tank and a second inlet connected to an outlet of the fourth tank, to perform the microfluidic process.

The method can still further include providing at least a portion of the combined first and second fluids back to the first tank, via an inlet connected to an outlet of the microfluidic channel. Alternatively, a portion of the combined fluids can be provided to a fifth tank of the device, via an inlet connected to a second outlet of the microfluidic channel, or connected near the inlet of the first tank. The method can be repeated, according to multiple iterations, until the desired microfluidic process is complete or until the first and/or second fluid supply is exhausted.

The apparatus or method allows for performing a microfluidic process as a single iteration or as a sequence of iterations. An iterative cycle using a smaller microfluidic channel can achieve similar results as a single process using a longer microfluidic channel. Moreover, after each iteration, the products and/or byproducts of the process can be analyzed, like an assay, such as an optical assay of the first tank after receiving the combined first and second fluids, for example. Iterative analysis can achieve benefits not found in single-cycle platforms.

The composition of the fluids determines the type of reaction that will occur between them. For instance, to accomplish extraction or separation, within the microfluidic channel, the first fluid may be a sample-bearing fluid, and the second fluid can be a receiver fluid for receiving the sample in a diffusion process. For a dilution process, the first fluid will include a sample, and the second fluid will include a diluent that is active when combined with the first fluid in the microfluidic channel.

The microfluidic channel can include, among various microfluidic devices, an H-filter extractor such as those described in U.S. Pat. No. 5,932,100 to Yager et al, assigned to Micronics Inc, and incorporated by reference herein for all purposes. The microfluidic channel may also include a mixer for performing the dilution process. These processes and the microfluidic devices to accomplish the processes are exemplary, and those with skill in the relevant art would recognize that the microfluidic channel may include any number and types of microfluidic devices for performing a process or causing a reaction among two or more fluids flowing in parallel. Accordingly, this invention is not to be limited to the specific illustrative cases described herein.

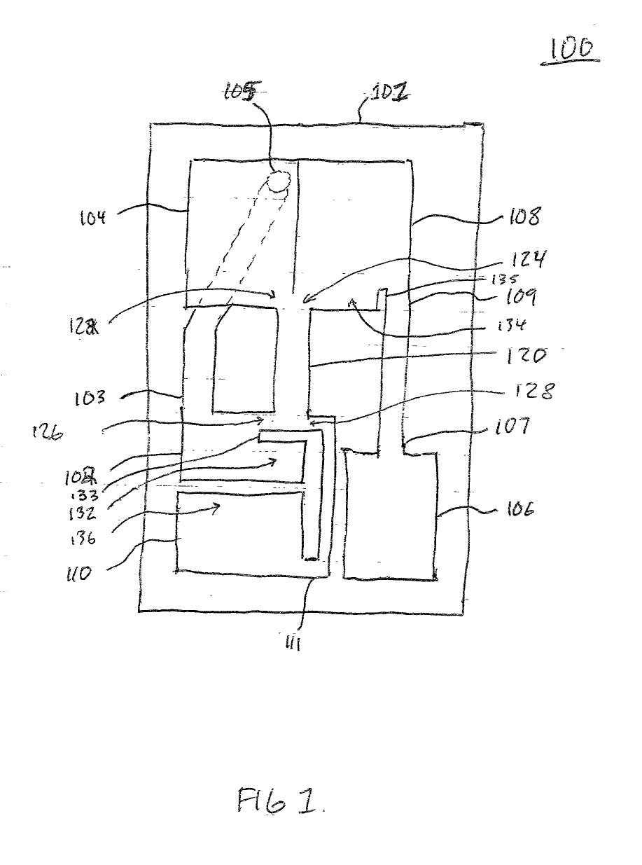

FIG. 1 shows an apparatus 100 for performing a microfluidic process, according to one embodiment of the invention. The apparatus 100 includes a number of tanks, formed and arranged within a cartridge 101. The cartridge 101 is preferably made of a single material, and as a unitary device. Materials such as plastic, metal, or silicon may be used to construct the cartridge. The cartridge may also be constructed by injection molding, material deposition and etching, or other suitable fabrication technique. In one embodiment, the cartridge is approximately the size and thickness of a typical credit card. However, in other embodiments, the cartridge can be of any size, shape or thickness.

According to a preferred embodiment, the apparatus 100 includes a first tank 102, also called a sample tank, in which a fluid including a sample is initially provided. The sample-bearing fluid can be injected into the first tank 102 by any desirable mechanism, such as through a small valve or membrane, for example. The first tank 102 includes an outlet 103 that is connected to an inlet 105 of a second tank 104. The second tank 104 is a product tank, adapted to receive the sample-bearing fluid from the first tank 102. The outlet 103 of the first tank and the inlet 105 of the second tank 104 may form a channel, or may be connected by a different channel, of any desired length. The connection between the first tank 102 and the second tank 104 is arranged to allow fluid to manually flow under the force of gravity, according to an orientation of the apparatus 100.

The apparatus 100 includes a third tank 106, also called a receiver tank, preferably disposed adjacent to the first tank and in which a receiver fluid is initially provided. Providing the receiver fluid to the third tank may also be accomplished by any suitable mechanism. The third tank 106 includes an outlet 107 connected to an inlet 109 of a fourth tank 108, also known as a receiver metering tank. The fourth tank 108 is preferably disposed adjacent to the second tank 104, and is sized and adapted to contain a particular, metered amount of the receiver fluid. For instance, the fourth tank can include a dam structure and protrusion that are configured to hold a particular amount of receiver fluid. Excess receiver fluid of the particular amount can flow over the dam and back into the third tank 106. In an alternative embodiment, the second tank 104 and third tank 108 can be juxtaposed and divided by a wall or a membrane, which has an opening therein. The receiver fluid is transferred from the third tank 106 to the fourth tank 108. A channel is formed, or a channel may be connected between, the third tank outlet 107 and the fourth tank inlet 109.

The apparatus 100 further includes a microfluidic channel 120 disposed between the tanks. The microfluidic channel 120 is specifically sized and arranged to accomplish a microfluidic process. The microfluidic channel 120 has a first inlet 122 connected to an outlet of the second tank 104, and a second inlet 124 connected to an outlet of the fourth tank 108. In an embodiment, the inlets of the microfluidic channel 120 and the outlets of the respective second and fourth tanks 104, 108 define a passageway. In another embodiment, the inlets and outlets can connected via a channel. The microfluidic channel 120 receives at least a portion of the sample bearing fluid from the second tank 104, and at least a portion of the receiver fluid from the fourth tank 108 in a substantially parallel flow.

The microfluidic channel 120 includes at least one outlet 126 for depositing at least a portion of the combined fluids back to the first tank 102. Also, a fifth tank 110, or waste tank, may be provided and connected to a second outlet 128 of the microfluidic channel 120 by an inlet 111. The waste tank can also receive at least a portion of the combined fluids, and preferably receives a portion that is unusable or undesirable for the subsequent iterations of the microfluidic process.

Backflow from any of the tanks The first tank 102 can include a protrusion 132 formed by a dam 133 for preventing or inhibiting backflow either into the microfluidic channel 120, or into the fifth tank 110. The fourth tank 108 may also include a similar protrusion 134, for preventing backflow of the receiver fluid to the third tank 106, or, as indicated above, to maintain only a measured amount of a particular fluid within the fourth tank 108 while in the second position. The fifth tank may also include a protrusion 136 to prevent backflow. Other mechanisms for preventing or inhibiting backflow of fluids may also be suitable used, such as oneway miniature valves, for example.

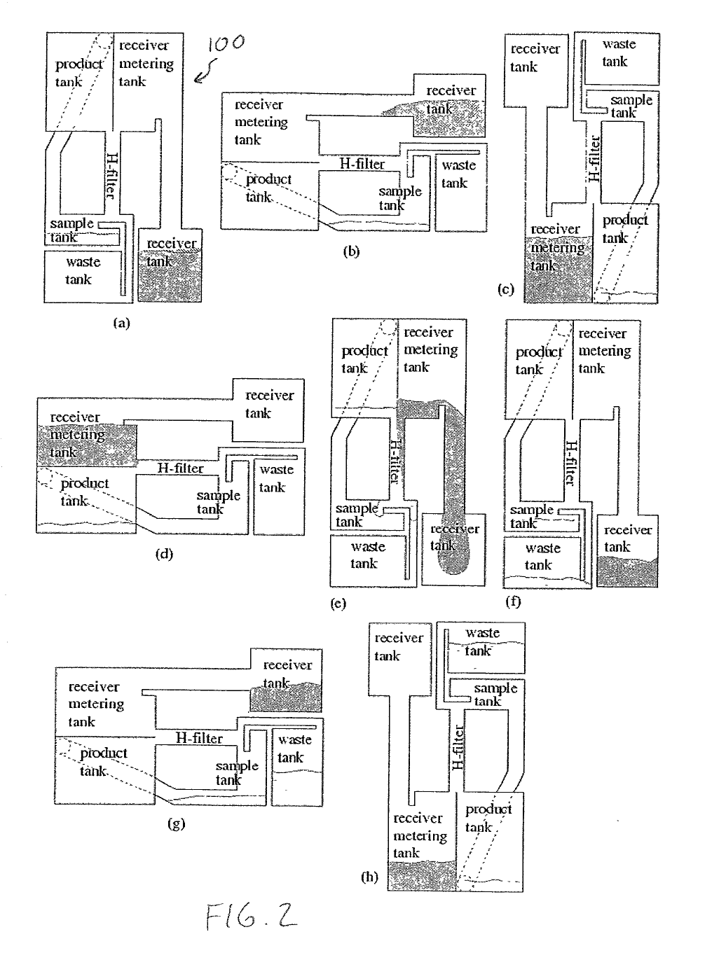

Turning now to FIG. 2, and with occasional reference to FIG. 1, a method for performing one iteration of a sequential microfluidic extraction process is illustrated. For simplicity, the cartridge 101 from FIG. 1 is not shown in FIG. 2.

In FIG. 2(a), the apparatus 100 is provided in a first position, the sample fluid initially loaded into the first tank 102, and the receiver fluid loaded into the third tank 106. In FIG. 2(b), the apparatus 100 is rotated in order to allow both fluids to flow from their respective tanks. In FIG. 2(c), the apparatus is rotated approximately to a second position, preferably about 180 degrees, in which the fluid from the first tank 102 is transferred to the second tank 104, and the fluid from the third tank 106 is transferred to the fourth tank 108.

In FIGS. 2(d) and 2(e), the apparatus is rotated back to the first position to start the flow of both fluids into the microfluidic channel 120 from the second and fourth tanks 104, 108 respectively. Any receiver fluid in excess of a metered portion contained within the protrusion 134 will flow over the dam 135 and back to the third tank 106. Both fluids also flow through the microfluidic channel 120, where the extraction occurs, and then into the first tank 102 and/or into the fifth tank 110, as shown in FIGS. 2(e) and 2(f).

The apparatus 100 is then again rotated from the first position toward the second position to recharge the second and fourth tanks, as shown in FIGS. 2(g) and 2(h), in order to begin another iteration of the extraction process. The method steps shown in FIGS. 2(d) to 2(h) are repeated until the extraction process is complete or the receiver fluid supply is exhausted.

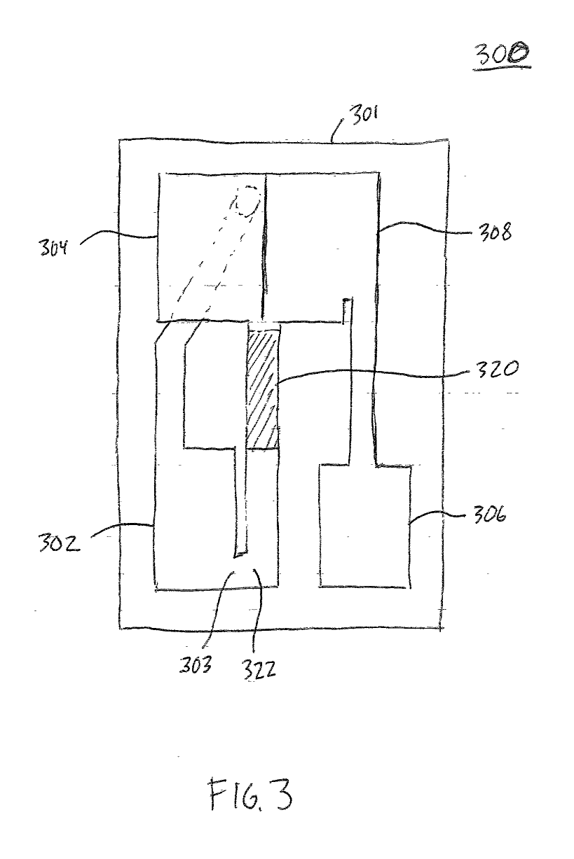

The invention may be used to perform other microfluidic processes. FIG. 3 shows an alternative embodiment of the invention, configured to perform a dilution process. An apparatus 300 for performing a dilution process includes a first tank 302 that is connected to a second tank 304, a third tank 306 that is connected to a fourth tank 308, and a microfluidic channel 320 that is connected at inlets to the second and fourth tanks 304, 308, and to an outlet to the first tank 302. Each of the connections provides fluid movement from one tank or channel to another tank, depending on the rotation or orientation of the apparatus 300. The microfluidic channel 320 according to this embodiment includes any type of mixer.

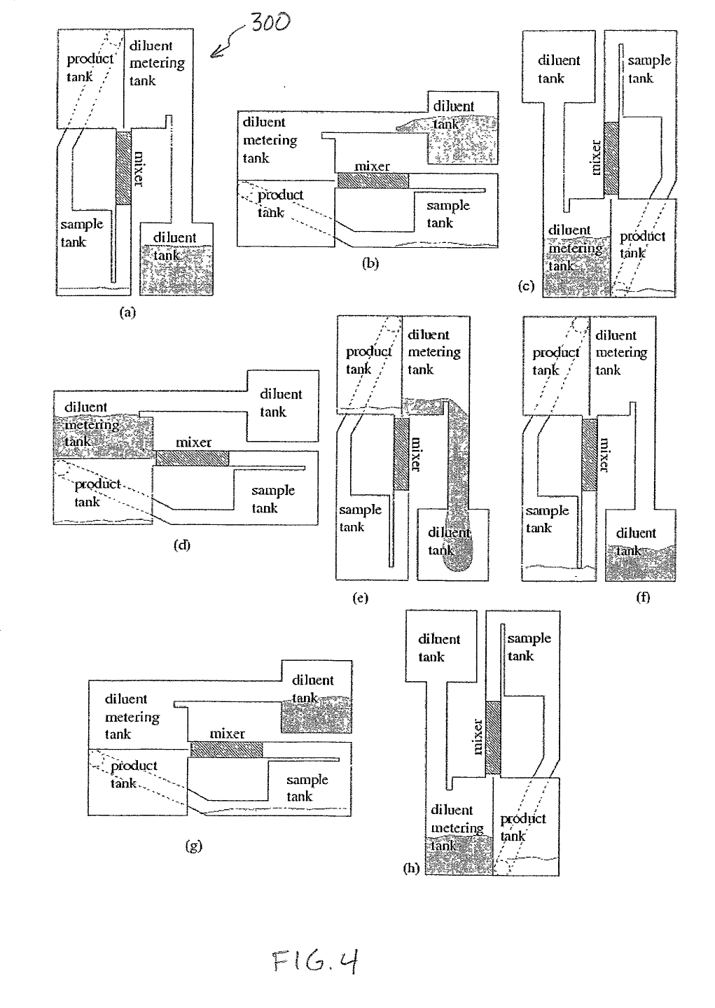

Operation of the device 300 is illustrated in FIGS. 4(a)-(h). FIG. 4(a) illustrates a first position of the apparatus 300 in which a sample is initially loaded in the first tank 302, and the diluent is initially loaded in the third tank 306. Rotation of the device to a second position, as shown in FIGS. 4(b) and 4(c), causes a flow of each of the sample and diluent fluids to the second and fourth tanks 304, 308 respectively. Rotation of the device back from the second position to the first position, as shown in FIGS. 4(e) and 4(f), allows the sample and diluent fluids to combine in the microfluidic channel 320, and any excess diluent to flow back to the third tank 306.

FIGS. 4(g) and 4(h) illustrate rotation of the device from the first position to the second position to begin another iteration of the dilution process. The steps illustrated by FIGS. 4(d)-4(h) are repeated until the sample is adequately diluted, the diluent is used up, or the appropriate analysis is completed.

Other arrangements, configurations and methods should be readily apparent to a person of ordinary skill in the art. Other embodiments, combinations and modifications of this invention will occur readily to those of ordinary skill in the art in view of these teachings. Therefore, this invention is to be limited only be the following claims, which include all such embodiments and modifications when viewed in conjunction with the above specification and accompanying drawings.

What is claimed is:

1. An apparatus for performing a microfluidic process, comprising:
a first tank;
a second tank having an inlet connected to an outlet of the first tank;
a third tank adjacent to the first tank;
a fourth tank, adjacent to the second tank, and having an inlet connected to an outlet of the third tank; and
a microfluidic channel, having a first inlet connected to an outlet of the second tank, a second inlet connected to an outlet of the fourth tank, and a first outlet connected to an inlet of the first tank.

2. The apparatus of claim 1, further comprising a fifth tank having an inlet connected to a second outlet of the microfluidic channel.

3. The apparatus of claim 2, wherein the microfluidic channel includes an H-filter extractor.

4. The apparatus of claim 1, wherein the microfluidic channel includes a mixer.

5. The apparatus of claim 1, wherein the first, second, third, and fourth tanks are disposed within a common plane.

6. The apparatus of claim 5, wherein first, second, third and fourth tanks are formed in a cartridge.

7. The apparatus of claim 1, wherein the inlet of the second tank is diposed on an opposite side as the outlet of the second tank.

8. The apparatus of claim 1, wherein the fourth tank includes a protrusion for containing a metered amount of a fluid.

9. The apparatus of claim 1, wherein the first tank includes a protrusion to prevent backflow of a fluid to the inlet of the first tank.

10. The apparatus of claim 2, wherein the fifth tank is arranged so as to prevent backflow of a fluid to the inlet of the fifth tank.

11. An apparatus for performing a microfluidic process, comprising:
a rotatable, substantially planar cartridge, having:
a first tank;
a second tank having an inlet connected to an outlet of the first tank;
a third tank adjacent to the first tank;
a fourth tank, adjacent to the second tank, and having an inlet connected to an outlet of the third tank; and
a microfluidic channel, having a first inlet connected to an outlet of the second tank, a second inlet connected to an outlet of the fourth tank, and a first outlet connected to an inlet of the first tank.

12. A rotatable, gravity-driven device for performing a sequential microfluidic process, comprising:
a first tank for containing a first fluid when the device is in a first position;
a second tank having an inlet connected to an outlet of the first tank for receiving at least a portion of the first fluid during rotation of the device from the first position to a second position;
a third tank, adjacent to the first tank, for containing a second fluid in the first position;
a fourth tank, adjacent to the second tank, and having an inlet connected to an outlet of the third tank for receiving a least a portion of the second fluid during rotation from the first position to the second position; and
a microfluidic channel, having a first inlet connected to an outlet of the second tank, a second inlet connected to an outlet of the fourth tank, and a first outlet connected to an inlet of the first tank, the microfluidic channel receiving at least a portion of the first fluid from the second tank and at least a portion of the second fluid from the fourth tank when the device is restored to the first position from the second position to perform the microfluidic process.

13. The device of claim 12, further comprising a fifth tank, having an inlet connected to a second outlet of the microfluidic channel, for receiving at least a portion of the combination of first and second fluids.

14. The device of claim 12, wherein the first fluid is a sample bearing fluid.

15. The device of claim 14, wherein the second fluid is a sample-reactant fluid.

16. The device of claim 15, wherein the sample-reactant fluid is a receiver for receiving at least a portion of the sample from the sample-bearing fluid.

17. The device of claim 15, wherein the sample-reactant fluid is a diluent for diluting at least a portion of the sample in the sample-bearing fluid.

18. The device of claim 16, wherein the microfluidic channel includes an H-filter extractor.

19. The device of claim 17, wherein the microfluidic channel includes a mixer.

20. The device of claim 12, wherein the first, second, third, and fourth tanks are contained within a cartridge.

21. A method for performing a microfluidic process with a unitary device, comprising:
providing a first fluid to a first tank of the device;
transferring at least a portion of the first fluid to a second tank of the device via an inlet connected to an outlet of the first tank;
providing a second fluid to a third tank of the device adjacent to the first tank;
transferring at least a portion of the second fluid to a fourth tank of the device adjacent to the second tank, via an inlet connected to an outlet of the third tank; and
combining the first fluid from the second tank with the second fluid from the fourth tank in a microfluidic channel of the device, via a first inlet connected to an outlet of the second tank and a second inlet connected to an outlet of the fourth tank, to perform the microfluidic process.

22. The method of claim 21, further comprising providing at least a portion of the combined first and second fluids to the first tank via an inlet connected to an outlet of the the microfluidic channel.

23. The method of claim 21, wherein providing a first fluid to a first tank includes placing the device in a first position.

24. The method of claim 23, wherein transferring at least a portion of the first fluid to a second tank includes rotating the device from the first position to a second position.

25. The method of claim 24, wherein the second position is approximately 180 degrees from the first position.

26. The method of claim 23, wherein providing a second fluid to a third tank includes placing the device in the first position.

27. The method of claim 26, wherein transferring at least a portion of the second fluid to a fourth tank includes rotating the device from the first position to the second position.

28. The method of claim 27, wherein combining the first fluid from the second tank with the second fluid from the fourth tank in a microfluidic channel includes restoring the device to the first position from the second position.

29. The method of claim 21, wherein transferring the first fluid and transferring the second fluid are performed substantially simultaneously.

30. The method of claim 21, further comprising providing at least a portion of the combined first and second fluids to a fifth tank via an inlet connected to an outlet of the microfluidic channel.

31. The device of claim 21, wherein the first fluid is a sample-bearing fluid.

32. The device of claim 31, wherein the second fluid is a sample-reactant fluid.

33. The device of claim 32, wherein the sample-reactant fluid is a receiver for receiving at least a portion of the sample from the sample-bearing fluid.

34. The device of claim 32, wherein the sample-reactant fluid is a diluent for diluting at least a portion of the sample in the sample-bearing fluid.

35. The device of claim 33, wherein the microfluidic channel includes an H-filter extractor.

36. The device of claim 34, wherein the microfluidic channel includes a mixer.

37. In combination with a unitary device, a method for producing a sequential extraction of a sample from a sample-bearing fluid to a receiver fluid, the method comprising:
a) providing the sample-bearing fluid to a first tank of the device;
b) transferring at least a portion of the sample-bearing fluid to a second tank of the device via an inlet connected to an outlet of the first tank;
c) providing the receiver fluid to a third tank of the device adjacent to the first tank;
d) transferring at least a portion of the receiver fluid to a fourth tank of the device adjacent to the second tank, via an inlet connected to an outlet of the third tank; and
e) combining the sample-bearing fluid from the second tank with the receiver fluid from the fourth tank in a H-filter extractor of the device, via a first inlet connected to an outlet of the second tank and a second inlet connected to an outlet of the fourth tank, to perform an iteration of the extraction.

38. The method of claim 37, further comprising repeating steps (a)-(e) to perform a subsequent iteration of the sequential extraction.

39. In combination with a unitary device, a method for producing a sequential dilution by a diluent fluid of a sample in a sample-bearing fluid, the method comprising:
a) providing the sample-bearing fluid to a first tank of the device;
b) transferring at least a portion of the sample-bearing fluid to a second tank of the device via an inlet connected to an outlet of the first tank;
c) providing the diluent fluid to a third tank of the device adjacent to the first tank;
d) transferring at least a portion of the diluent fluid to a fourth tank of the device adjacent to the second tank, via an inlet connected to an outlet of the third tank; and
e) combining the sample-bearing fluid from the second tank with the diluent fluid from the fourth tank in a mixer of the device, via a first inlet connected to an outlet of the second tank and a second inlet connected to an outlet of the fourth tank, to perform an iteration of the dilution.

40. The method of claim 39, further comprising repeating steps (a)-(e) to perform a subsequent iteration of the sequential dilution.

41. In combination with a device having a first tank, a second tank having an inlet connected to an outlet of the first tank, a third tank adjacent to the first tank, a fourth tank adjacent to the second tank and having an inlet connected to an outlet of the third tank, and a microfluidic channel having a first inlet connected to an outlet of the second tank, a second inlet connected to an outlet of the fourth tank, and a first outlet connected to an inlet of the first tank, a method of performing a microfluidic reaction comprising:
positioning the device in a first position to provide a first fluid to the first tank;
providing, in the first position, a second fluid to the third tank;
rotating the device from the first position to a second position to transfer the first fluid from the first tank to the third tank, and to transfer the second fluid from the second tank to the fourth tank; and
rotating the device back to the first position from the second position to combine the first fluid from the third tank with the second fluid from the fourth tank in the microfluidic channel.
